(19) United States
(12) Patent Application Publication
(10) Pub. No.: US 2016/0158992 A1
(43) Pub. Date: Jun. 9, 2016

(54) METHOD FOR ATTACHING AN ACCESSORY TO THE WALL OF A VESSEL

(71) Applicant: PLASTIC OMNIUM ADVANCED INNOVATION AND RESEARCH, Bruxelles (BE)

(72) Inventors: Bjorn CRIEL, SINT-MARTENS-LENNIK (BE); Eric BOUCAUX, ELINCOURT SAINTE MARGUERITE (FR)

(73) Assignee: PLASTIC OMNIUM ADVANCED INNOVATION AND RESEARCH, Brussels (BE)

(21) Appl. No.: 14/906,828

(22) PCT Filed: Jul. 10, 2014
(86) PCT No.: PCT/EP14/64839

§ 371 Date: Jan. 21, 2016

(30) Foreign Application Priority Data
Jul. 22, 2013 (FR) 1357210

(51) Int. Cl. B29C 49/20; B29C 49/58; B60K 15/03; B29C 49/48

(52) U.S. Cl. CPC B29C 49/20; B29C 49/4802; B29C 49/58; B60K 15/03177; B29C 2049/2013; B29C 2049/5837; B29L 2031/7172

(57) ABSTRACT

A method for attaching a portion of an accessory to a wall of a vessel made of plastic, including shaping a parison by blowing. The accessory portion includes an attachment base including an open cavity including an opening leading to outside of the accessory portion, the open cavity including a female engagement shape shaped such that a male engagement shape complementary to the female engagement shape cannot, once engaged in the female engagement shape, be separated therefrom except by deformation or destruction of at least one of the engagement shapes. The method includes shaping a portion of the parison that is in a molten state, by molding same inside the cavity by a pressure difference established on either side of the portion of the parison, until the portion of the parison has a male engagement shape complementary to the female engagement shape formed by the open cavity.

The present invention relates to the technical field of fuel tanks.

The applicant company has already, in document EP1773570, divulged a method for fixing, to the wall of a fuel tank obtained by blow-molding a parison, an accessory provided with an orifice in which method a small quantity of plastic from the parison is made to flow in order to form an attachment rivet.

However, that method requires the provision, on the side of the core of the mold, of a counter-form actuated by an actuator.

The present invention seeks to propose a method in which no counter-form is needed for attaching the accessory to the wall of the tank.

One subject of the invention is a method for attaching part of an accessory to a wall of a plastic tank, comprising a step of shaping a parison by blow-molding, in which method the accessory part comprises an attachment base and the attachment base comprises an open cavity having a mouth opening to the outside of the accessory part, said open cavity constituting a female engagement shape shaped so that a male engagement shape, that complements this female engagement shape, cannot, once engaged in the female engagement shape, become detached therefrom other than by deforming or destroying at least one of the two engagement shapes, the method being characterized in that it comprises a step of shaping a part of the parison that is in the molten state, by molding inside the cavity, under the effect of a pressure difference established solely by contact of said part of the parison with a fluid across said part of the parison until said part of the parison adopts a male engagement shape that complements the female engagement shape constituted by the open cavity.

By virtue of the invention, that part of the parison that is shaped by molding inside the cavity constitutes an engagement shape which mechanically secures the accessory part to the parison, after the latter has cooled and therefore become rigid.

In other words, the parison engages in the cavity of the base of the accessory part without the need to be pierced, thereby guaranteeing that the tank is suitably fluid tight.

According to the invention, the expression “solely by contact of said part of the parison with a fluid” means that the part of the parison deforms only by the action of blowing. Thus, the part of the parison does not experience the action of a punch or any other moving part of the mold that might contribute to deforming it in order to cause it to conform to the inside of the cavity.

One fluid that can be used according to the invention may be air or a gaseous mixture of a composition similar to that of ambient air. This choice, which is preferred for reasons of convenience notably because air is also often the pressurized gas used for blow-molding the parison in its entirety, is not, however, limiting.

One significant advantage afforded by the invention is that the engagement shape resulting from the molding of the part of the parison in the cavity, which is obtained only by blowing, is of relatively uniform thickness. Indeed, because of the absence of any mechanical action on the part of the parison (aside from the action of the cavity itself), the material of which the parison is made can stretch and deform without experiencing nip or local tension at any particular points. In particular, the engagement shape will not have any pronounced beading which characterizes the shaping of sheets of plastic by flow under mechanical pressure. As a result, the engagement shape will not have any regions of internal stress concentration which, were they to exist, would weaken it.

In one particular embodiment, the method further comprises a step of bringing the mouth of the cavity of the attachment base into contact with the part of the parison that is in the molten state, this step being carried out before said part of the parison is shaped by molding. This prior step makes it easier to deform the parison under the effect of the pressure difference created across the parison. If beading forms in the parison during this contact, because of the light pressure applied across the parison between the mouth of the cavity and the mold, the beading will be situated around the mouth of the cavity and therefore on the outside of the engagement shape. Therefore this will not weaken the engagement shape.

In another embodiment which is compatible with the previous one, the method further comprises a step of cooling said part of the parison so that the latter constitutes a male engagement shape that complements the female engagement shape constituted by the cavity and so that the two complementing shapes cannot become detached other than by deforming or destroying at least one of them. This cooling may take place in a controlled fashion, using special purpose cooling means.

Furthermore, like with the method already divulged in EP05764640, the mechanical connection thus created between the accessory part and the wall of the tank allows effective securing, even if these two parts are made of materials that are not chemically compatible. There is therefore no need to add compatibilizing agents or make the accessory from two different materials, one of them compatible with the material of the parison, as was the case in the prior art.

Finally, the parison may be made to conform to the interior shape of the cavity without the use of any counter-form, by creating a depression on the inside of the cavity or by blowing the parison into the cavity.

Another advantage of the invention is that the area of contact between the parison and the base of the accessory can be as large as needed, making it possible to adapt the dimensions of the attachment, and therefore the mechanical strength thereof, to the specification connected with the function that the accessory is to fulfill.

The invention may cover various types of accessory. In one particular embodiment, the accessory is chosen from the following list: a reinforcing pillar, a valve, a gauge, an anti-slosh device (known in the field of the invention by its English name “slosh noise baffles”), a support for one of these elements.

According to one first embodiment, the method is performed on a reservoir blow-molding mold and comprises the following steps:

seizure of the accessory part by a core of the mold,

positioning of a parison between the core and a molding cavity of the mold,

movement of the core and of the molding cavity closer together preferably until the mouth of the cavity of the accessory part is in contact with the parison which is itself pressed firmly against the molding cavity,

establishing of a pressure difference across the part of the parison situated in line with the cavity until part of the parison is shaped like the inside of the cavity,

at least local cooling of the part of the parison thus shaped until the parison can ensure the mechanical integrity of the accessory part,

movement of the core away from the molding cavity,

removal of the core.

“In contact with the parison” means that the mouth of the cavity of the accessory is very close to the parison and sufficiently isolates the part of the parison that is to be shaped to conform to the inside of the cavity so that the shaping can be carried out without it disturbing the blow-molding of the rest of the parison. According to the embodiment adopted for establishing the pressure difference across the part of the parison situated in line with the cavity, it may prove necessary for the mouth of the cavity to touch the parison, and even to penetrate therein enough to create a seal.

An “accessory part” means either a bit of a whole accessory, via which bit this accessory is attached to the tank by virtue of the invention or a separate element to which the rest of the accessory will be attached after the invention has been implemented, using mechanical means of attachment such as clip-fastening, screw-fastening, socket jointing, welding or any other mechanical means of joining two elements together. The accessory part may thus be an attachment leg of an attached element that a person skilled in the art may refer to as an “accessory” even though it has no attachment leg, in which case in the present invention the actual accessory will be considered to be the assembly of the leg and of the attached element without an attachment leg.

Another subject of the invention is a method for producing a plastic tank, this method comprising the steps of the method described hereinabove, supplemented with a step of finalizing the molding of the parison until a tank is obtained.

In one particular embodiment of the invention, this method applies to the manufacture of a tank comprising at least one accessory intended to be fixed to two opposite walls of said tank, said accessory comprising a first cavity and a second cavity one at each of its opposite ends. This method comprises the following steps:

seizure of the accessory by a core of the mold,

positioning of a split parison or an at least two-part parison with one part on each side of the core, respectively between said core and a first molding cavity and between the core and a second molding cavity,

moving the core and the first molding cavity closer together, preferably until the mouth of the first cavity of the accessory is in contact with the parison, which is itself pressed firmly against the first molding cavity,

establishing of a pressure difference across the part of the parison that is situated in line with the first cavity until the part of the parison is shaped like the inside of the first cavity,

at least local cooling of the part of the parison thus shaped or the maintaining of the pressure difference so that the parison can ensure the mechanical integrity of the accessory,

release of the accessory by the core,

moving of the core away from the first molding cavity,

removal of the core,

moving of the first and second molding cavity closer together, preferably until the mouth of the second cavity of the accessory is in contact with the parison, which is itself pressed firmly against the second molding cavity,

establishing of a pressure difference across the part of the parison that is situated in line with the mouth of the second cavity, until the part of the comparison is shaped like the inside of the second cavity,

a finalizing of the molding of the parison until a tank is obtained.

It is not precluded, according to the invention, for the mold to comprise more than two molding cavities.

Likewise it is not precluded for the parison to be split in a single point and to form a kind of tube open longitudinally or split at various points to form longitudinal strips, the number of these strips not intending to be limited to two. Several strips or sheets constituting a parison may furthermore be the result of some other method of obtaining the parison than a method in which the parison is split.

A further subject of the invention is a plastic tank connected to the accessory part by complementing engagement shapes. Thus, the tank that forms the subject of the invention is obtained by blow-molding a parison into shape. It comprises an accessory part comprising an attachment base comprising an open cavity constituting a female engagement shape shaped so that a male engagement shape, that complements this female engagement shape, cannot, once engaged in the female engagement shape, become detached therefrom other than by deforming or destroying at least one of the two engagement shapes. This tank is characterized in that its exterior wall comprises a part shaped inside the cavity, into a male engagement shape that complements the female engagement shape constituted by said open cavity.

The invention will be better understood from studying the attached figures which are given by way of entirely nonlimiting example and in which:

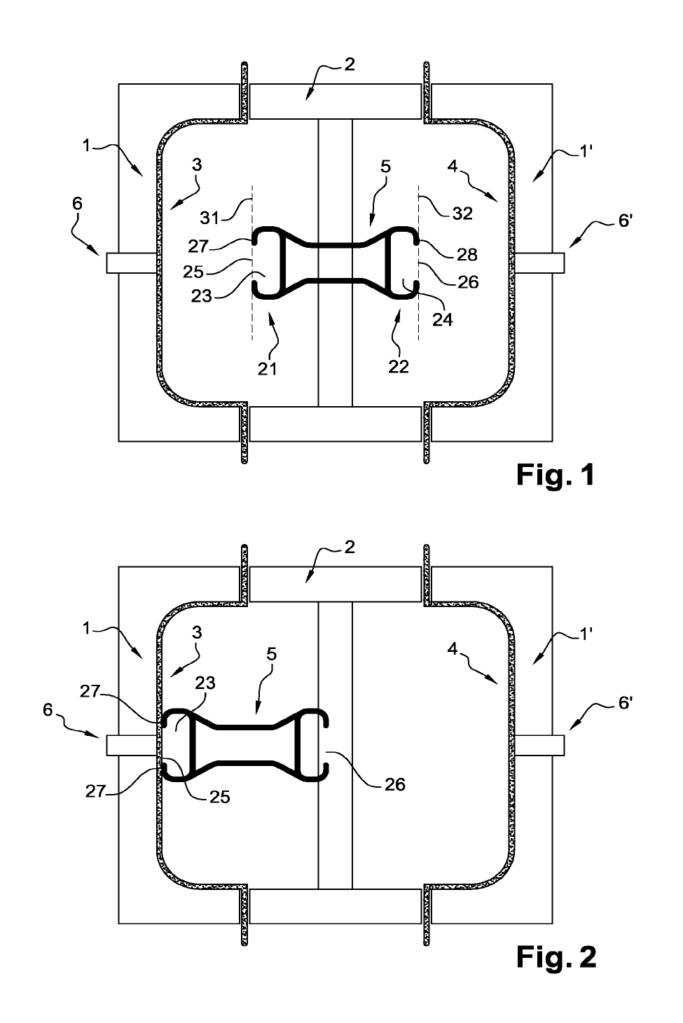

FIG. 1 is a schematic view in cross section of a mold for manufacturing a plastic tank during a step of a first embodiment of a method according to the invention.

FIG. 2 is a view similar to FIG. 1, during a later step of the first embodiment of the method.

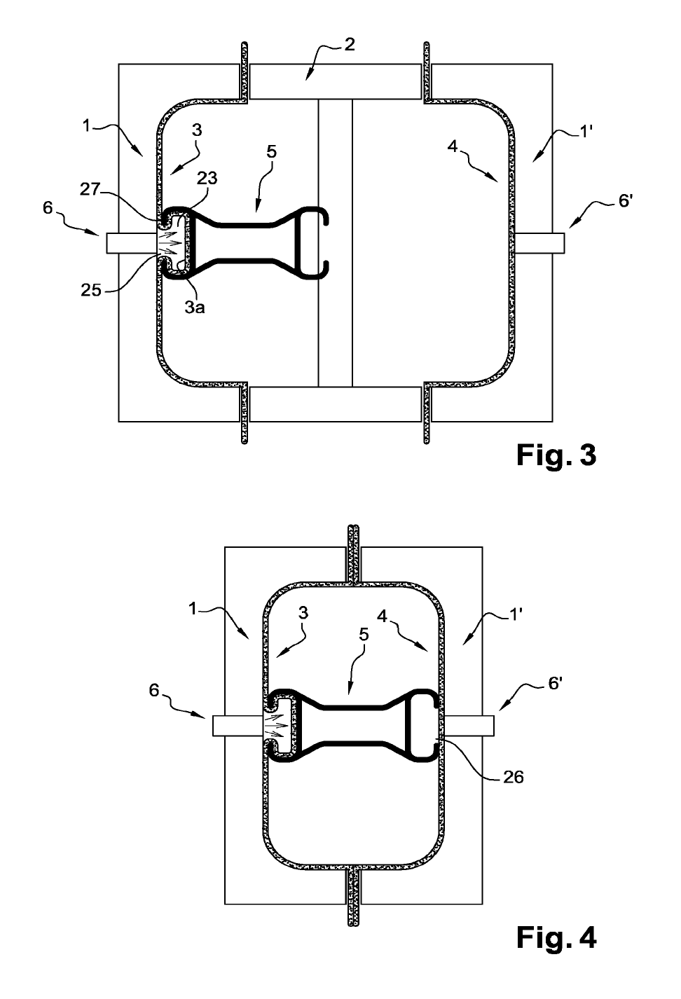

FIG. 3 is a view similar to FIG. 2, during a later step of the first embodiment of the method.

FIG. 4 is a view similar to FIG. 3 during a later step of the first embodiment of the method.

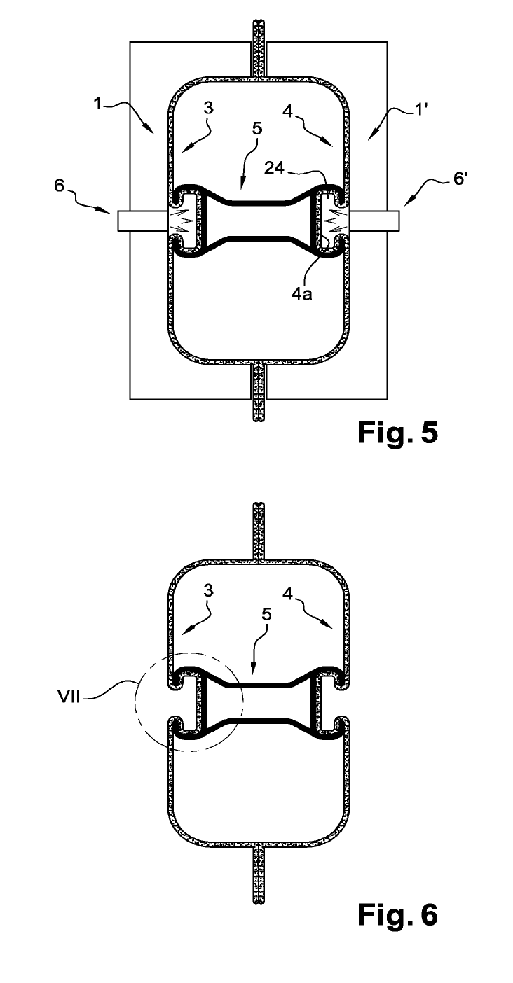

FIG. 5 is a view similar to FIG. 4, during a later step of the first embodiment of the method.

FIG. 6 is a schematic view in cross section of a tank obtained by implementing the method.

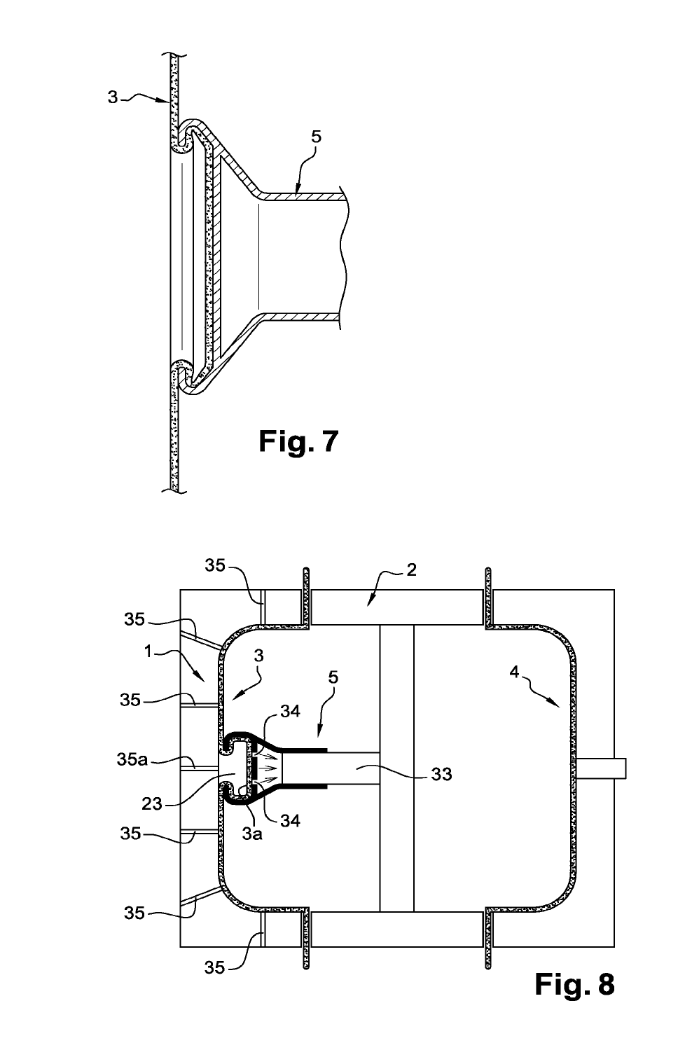

FIG. 7 is an enlargement of detail VII of FIG. 6.

FIG. 8 is a schematic view in cross section of a step similar to that of FIG. 3 but according to a second embodiment of the method according to the invention.

Reference is now made to FIG. 1 which shows a mold consisting of two molding cavities 1 and 1′ and of an accessory bearing core 2 which bears an accessory 5 via a grasping means which has not been depicted. In the example illustrated, this accessory 5 is a reinforcing pillar. A reinforcing pillar is an element intended to extend between two opposite walls of a tank in order to hold them a constant distance apart, notably preventing the tank from collapsing or distending.

Each of the two molding cavities 1 and 1′ comprises a blowing nozzle 6, 6′ which allows pressurized air to be introduced from outside the mold into the mold. Each blowing nozzle 6, 6′ opens into the mold in a flush manner such that the interior wall of each molding cavity is smooth enough that it does not impede the blow-molding of a parison. The term “nozzle” is sometimes replaced by the term “needle”.

In this example, it can be seen that the parison is made up of two sheets 3 and 4. These two sheets may come from a known method for extruding the parison above the mold, using an extruder and an extrusion head, neither of which have been depicted.

The accessory 5, which in this instance is a tank reinforcing pillar, comprises two opposite ends 21 and 22. At each of its ends it is shaped to define a cavity 23, 24 which has a mouth 25, 26.

Each cavity 23, 24 has an interior shaping such that, by gauging with a male part of complementing shape, it will be permanently secured to this male part, which means to say that the two, male and female, parts will no longer be able to be detached other than by deforming or destroying at least one of them. More specifically, although nonlimitingly, each cavity 23, 24 comprises a mouth 25, 26 formed by a re-entrant edge 27, 28 which partially closes the cross section of the cavity 23, 24.

Each mouth 25, 26 lies in a plane 31, 32 which is substantially perpendicular to the longitudinal axis of the accessory 5.

In the example illustrated, because the pillar exhibits symmetry of revolution, the cavities 23, 24 likewise exhibit symmetry of revolution.

During a first step, the two molding cavities 1 and 1′ and the core 2 are separated from one another so to allow the two sheets 3, 4 of the parison to be interposed respectively between the first molding cavity 1 and the core 2 and between the core 2 and the second molding cavity 1′.

During a second step illustrated in FIG. 1, the two molding cavities 1 and 1′ are brought closer to the core 2 and, in the known way, pressurized air is injected into the mold so as to press the two sheets 3 and 4 firmly against the interior wall of each of the two molding cavities 1 and 1′.

The pressurized air is injected using one or more blow pins which have not been depicted.

In a following step, illustrated in FIG. 2, the accessory 5 is moved by the grasping means, which for this purpose may comprise an actuating cylinder which has not been depicted, toward the first molding cavity 1. Its mouth 25 comes into contact with the sheet 3 of the parison which, although already formed by blow-molding, is still in the molten state.

The contact effected in this way must be sufficient that the edge 27 penetrates the parison 3 slightly and creates a seal between, on the one hand, the volume (for the moment, flat) comprised between the molding cavity 1 and that part of the parison that lies in line with the mouth 25 and, on the other hand, the volume comprised between the molding cavity 1 and the rest of the parison around the mouth 25. In other words, the air injection nozzle 6 carries no risk of injecting air beyond the edge 27, as if it did this could have a detrimental effect on the blow-molding of the rest of the parison.

In a next step, illustrated in FIG. 3, pressurized air is injected into the air injection nozzle 6 of the first molding cavity 1. This injection of air causes the part 3a of the sheet 3 that lies in line with the mouth 25 of the cavity 23 to be shaped by blow-molding. This part 3a of the parison accordingly adopts a shape that complements that of the cavity 23 and as a result constitutes a male engagement shape engaged in a female engagement shape constituted by the cavity 23. If the cavity is entirely closed, vents will of course have been provided in order to allow air trapped in the cavity 23 as it closes by the bringing-into-contact of its mouth 25 with the sheet 3 of the parison to escape. This shaping occurs in the absence of localized points at which material constituting the parison is retained, so the parison material can therefore stretch everywhere in substantially the same way, reducing in thickness uniformly throughout the engagement shape.

It may be noted that the initial direction of deformation of the parison brought about by the blow molding by the injection nozzle 6 is perpendicular to the main plane of the mouth 25 of the cavity 23.

Thanks to the part 3a of the parison thus shaped into a male engagement shape, the accessory 5 finds itself secured to the part 3 of the parison. The accessory bearing core 2 releases the accessory 5 and is withdrawn from between the two molding cavities 1 and 1′. The blow-molding pressure is maintained in the part 3a of the parison.

In a next step illustrated by FIG. 4, the two molding cavities 1 and 1′ are brought closer together until the mouth 26, opposite to the mouth 25, comes into contact with the sheet 4 of the parison.

In a next step illustrated by FIG. 5, pressurized air is injected into the injection nozzle 6′ of the molding cavity 1′ and this has the effect of conforming the part 4a of the sheet 4 to give it a shape that complements that of the cavity 24.

At the same time, or later or beforehand, the two sheets 3 and 4 of the parison are welded at the periphery of the mold in the known way.

As may be seen in FIG. 6, after demolding, the accessory 5 is mechanically secured to the two opposite walls of the tank, corresponding respectively to the two sheets 3 and 4 of the parison.

The way in which the parison shaped into a male piece that complements the cavity fits together with this cavity and mechanically anchors the accessory 5 to the wall of the tank can be seen better in the detail of FIG. 7.

The second embodiment, of which only the step of shaping the part 3a is illustrated by FIG. 8, which figure corresponds to FIG. 3 of the first embodiment, will now be described.

In this instance, the molding cavity 1 has no blowing nozzle. By contrast, the accessory bearing core 2 has a suction nozzle 33.

The accessory 5 is provided with holes 34 to place the cavity 23 and the nozzle 33 in fluidic communication as long as the accessory is being borne by the accessory bearing core 2.

Thus, during the step of FIG. 8, air suction is created in the suction nozzle 33, causing air present in the cavity 23 of the accessory to be sucked out and thereby causing a pressure difference across the parison, and causing the part 3a of the parison to be shaped as a male part hugging the shape of the cavity 23. As in the previous embodiment, this shaping occurs in the absence of localized points at which material is retained, so that the material can therefore stretch in substantially the same way throughout, reducing in thickness uniformly throughout the engagement shape.

According to the invention, the shaping of the part 3a of the parison is the result of a pressure difference, so that the sucking-out of air caused by the suction nozzle needs to create a vacuum stronger than the vacuum between the molding cavity 1 and the part 3a of the parison 3. To make it easier to shape the part 3a, it is therefore desirable to provide in the molding cavity 1 a fluidic communication passage 35a opening in line with the cavity 23 of the accessory, so as to place the region between the molding cavity 1 and the part 3a of the parison at atmospheric pressure. To do that, use may be made of the presence, within the molding cavity 1, of vents 35 usually employed to evacuate air trapped between the parison 3 and the molding cavity during the blow-molding of the parison.

Another possible way of creating the pressure difference required across the part 3a of the parison is for the vent 35a to be connected to the parison blow-molding circuit (which amounts to injecting air as in the first embodiment) and to connect the nozzle 33 to atmospheric pressure. The nozzle 33 therefore offers a leakage path for the air present in the cavity 23.

The invention is not restricted to the embodiments presented and other embodiments will become clearly evident to a person skilled in the art. Notably it is possible to give the cavities that constitute the female pieces of the engagement different shapes. For example, dovetail shapes not exhibiting symmetry of revolution may suit.

1-8. (canceled)

9: A method for attaching part of an accessory to a wall of a plastic tank, comprising:
shaping a parison by blow-molding, wherein the accessory part includes an attachment base and the attachment base includes an open cavity including a mouth opening to outside of the accessory part, the open cavity constituting a female engagement shape shaped so that a male engagement shape, that complements the female engagement shape, cannot, once engaged in the female engagement shape, become detached therefrom other than by deforming or destroying at least one of the male or female engagement shapes;
shaping a part of the parison that is in a molten state, by molding inside the cavity, under effect of a pressure difference established solely by contact of the part of the parison with a fluid across the part of the parison until the part of the parison adopts a male engagement shape that complements the female engagement shape constituted by the open cavity.

10: The method as claimed in claim 9, further comprising bringing the mouth of the cavity of the attachment base into contact with a part of the parison that is in the molten state, before the part of the parison is shaped by molding.

11: The method as claimed in claim 9, further comprising cooling the part of the parison so that the part of the parison constitutes a male engagement shape that complements the female engagement shape constituted by the cavity and so that the two complementing shapes cannot become detached other than by deforming or destroying at least one of them.

12: The method as claimed in claim 9, performed on a reservoir blow-molding mold and comprising:
seizure of the accessory part by a core of the mold;
positioning of a parison between the core and a molding cavity of the mold;
movement of the core and of the molding cavity closer together or until the mouth of the cavity of the accessory part is in contact with the parison which is itself pressed firmly against the molding cavity;
establishing a pressure difference across the part of the parison situated in line with the cavity until part of the parison is shaped like the inside of the cavity;
at least local cooling of the part of the parison thus shaped until the parison can ensure mechanical integrity of the accessory part;
movement of the core away from the molding cavity;
removal of the core.

13: A method for producing a plastic tank, comprising the method as claimed in claim 9, supplemented with finalizing the molding of the parison until a tank is obtained.

14: The method as claimed in claim 12, as applied to manufacture of a tank comprising at least one accessory configured to be fixed to two opposite walls of the tank, the accessory comprising a first cavity and a second cavity one at each of its opposite ends, the method comprising:
seizure of the accessory by a core of the mold;
positioning of a split parison or an at least two-part parison with one part on each side of the core, respectively between the core and a first molding cavity and between the core and a second molding cavity;
moving the core and the first molding cavity closer together, or until the mouth of the first cavity of the accessory is in contact with the parison, which is itself pressed firmly against the first molding cavity;
establishing of a pressure difference across the part of the parison that is situated in line with the mouth of the first cavity until the part of the parison is shaped like the inside of the first cavity;
at least local cooling of the part of the parison thus shaped or maintaining the pressure difference so that the parison can ensure mechanical integrity of the accessory;
release of the accessory by the core;
moving of the core away from the first molding cavity;
removal of the core;
moving of the first and second molding cavity closer together, or until the mouth of the second cavity of the accessory is in contact with the parison, which is itself pressed firmly against the second molding cavity;
establishing a pressure difference across the part of the parison that is situated in line with the mouth of the second cavity, until the part of the parison is shaped like the inside of the second cavity;
a finalizing of the molding of the parison until a tank is obtained.

15: The method as claimed in claim 9, wherein the accessory is chosen from: a reinforcing pillar, a valve, a gauge, an anti-slosh device, a slosh noise baffles, a support for one of these elements.

16: A plastic tank obtained by shaping, by blow-molding, a parison, comprising:
an accessory part comprising an attachment base comprising an open cavity constituting a female engagement shape shaped so that a male engagement shape, that complements the female engagement shape, cannot, once engaged in the female engagement shape, become detached therefrom other than by deforming or destroying at least one of the male or female engagement shapes,
an exterior wall of the tank comprises a part shaped inside the cavity, into a male engagement shape that complements the female engagement shape constituted by the open cavity.
